(19) United States
(12) Patent Application Publication
(10) Pub. No.: US 2007/0188329 A1
(43) Pub. Date: Aug. 16, 2007

(54) Fluid product dispenser member and dispenser comprising one such member

(76) Inventors: Firmin Garcia, Evreux (FR); Gerard Cornet, Blaru (FR)

Correspondence Address: SUGHRUE MION, PLLC, 2100 PENNSYLVANIA AVENUE, N.W., SUITE 800, WASHINGTON, DC, 20037, US

(21) Appl. No.: 10/583,255

(22) PCT Filed: Dec. 17, 2004
(86) PCT No.: PCT/FR04/50719

§ 371 Date: Jun. 16, 2006

(30) Foreign Application Priority Data
Dec. 19, 2003 (FR) 0315041

(51) Int. Cl. G08B 13/14; B67D 1/07; B65D 88/54; G01F 11/00; G06F 17/00

(52) U.S. Cl. 340/572.8; 222/192; 222/321.9; 222/321.1; 235/375

(57) ABSTRACT

A fluid-dispenser member (1) comprising: a body (10) defining an inlet duct (11); an actuator rod (13) that is displaceable in the body; an actuator member (15) coupled to the actuator rod; fastener means (17) for fastening the body (10) in an opening (20) of a receptacle (2) containing a fluid; and an ID unit (3) capable of supplying information relating to the dispenser member, the dispenser member being characterized in that said ID unit (3) is housed in a gap defined between the body (10) and the fastener means (17).

The present invention relates to a fluid-dispenser member comprising a body defining an inlet duct, an actuator rod that is displaceable in the body, an actuator member coupled to the actuator rod, and fastener means for fastening the body in an opening of a receptacle containing a fluid. This design is entirely conventional for a pump or a valve used in the fields of perfumery, cosmetics, or even pharmacy, for dispensing fluids contained in receptacles such as flasks, bottles, etc.

More particularly, the present invention relates to the ability to authenticate and to trace the dispenser member, or more generally the dispenser using such a dispenser member. It is important to be able to identify beyond any doubt the origin of the dispenser member so as to be able to distinguish quickly and easily between an authentic item and an imitation or a counterfeit. More particularly for traceability purposes, it is important to be able to follow the path or journey of the dispenser member from its manufacture to its sale or its offer for sale. A solution proposed by French patent application FR 2 832134 provides for one of the components constituting the dispenser member to be provided with an identity (ID) unit capable of supplying information relating to the dispenser member. The ID unit comprises an integrated circuit, and an antenna capable of transmitting signals carrying information. The signals can be of the radiofrequency type. The ID unit is thus capable of supplying information in the form of a signal in response to a transmitted information-request signal received by the antenna of the unit.

The ID unit of that application can be located at various locations within the dispenser member. However, it turns out that the locations proposed in the various embodiments present numerous drawbacks.

Positioning the ID unit on a ring engaged below the body of the pump or valve presents the problem of the unit and its support being visible through the receptacle. That particular positioning thus constitutes an appearance drawback.

Disposing the ID unit in the dispenser head also poses a problem, with it being possible to remove or pull off that head in order to replace it by a dispenser head that does not have such a chip, for example. That embodiment can thus be particularly problematic in building up evidence of counterfeiting.

In another embodiment described in that application, the ID unit is placed around the pump body on a support ring housed below the gasket in the opening of the receptacle. The drawback associated with that location is that the diameter of the opening must be calibrated, so as to leave enough space to insert the unit and its support therein. Consequently, that embodiment is not suitable for receptacle necks having diameters that are substantially identical to the diameters of the pump body, since the ring does not have enough space to be included between the pump body and the opening defined by the neck.

Finally, a last embodiment envisages mounting the ID unit on the neck gasket, in a special recess. A major drawback associated with that positioning lies in the possibility of the ID unit being crushed while the collar is being crimped on the receptacle, potentially causing said unit to malfunction, or even breaking it irreparably.

An object of the present invention is to remedy the above-mentioned prior-art drawbacks associated with the locations for housing an ID unit within a dispenser member or within a dispenser using such a member.

To achieve this object, the present invention proposes a fluid-dispenser member comprising: a body defining an inlet duct; an actuator rod that is displaceable in the body; an actuator member coupled to the actuator rod; fastener means for fastening the body in an opening defined in a receptacle containing a fluid; and an ID unit capable of supplying information relating to the dispenser member, the dispenser member being characterized in that said ID unit is housed in a gap defined between the body and the fastener means.

Advantageously, said gap is defined by a neck gasket disposed around the body, and designed to be compressed against the opening of the receptacle.

Advantageously, said gap forms an annular housing defined by the body, by a portion of the fastener means, and by the neck gasket.

Advantageously, said gap forms an annular housing defined by the body, by a crimped portion of the fastener means, and by the neck gasket.

Advantageously, said portion is engaged below a rim formed by the body.

In another embodiment, the ID unit may be fastened to the components constituting the dispenser member, or, in a variant, it may be disposed on, or encapsulated or embedded in, a substrate made of resin, for example.

The invention also relates to a fluid dispenser, such as a spray, comprising a receptacle and a dispenser member of the invention.

The invention is described in greater detail below with reference to the accompanying drawings, giving, by way of non-limiting examples, several embodiments of the invention.

In the figures:

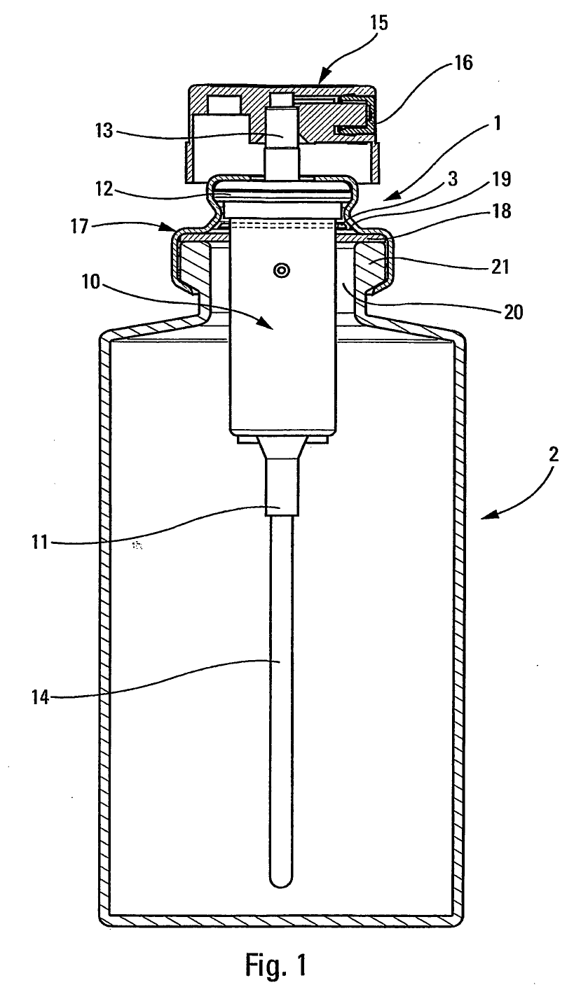

FIG. 1 is a fragmentary view in vertical section through a fluid dispenser provided with a dispenser member constituting an embodiment of the invention;

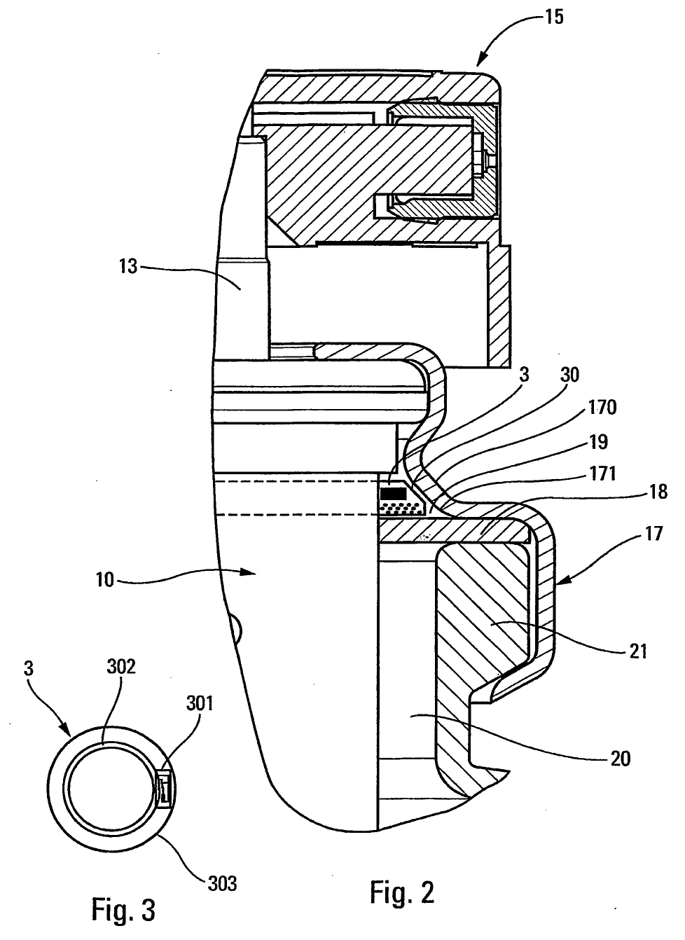

FIG. 2 is a greatly enlarged view of a portion of a dispenser using a dispenser member constituting an embodiment of the invention;

FIG. 3 is a diagrammatic view showing an embodiment of a radiofrequency ID unit;

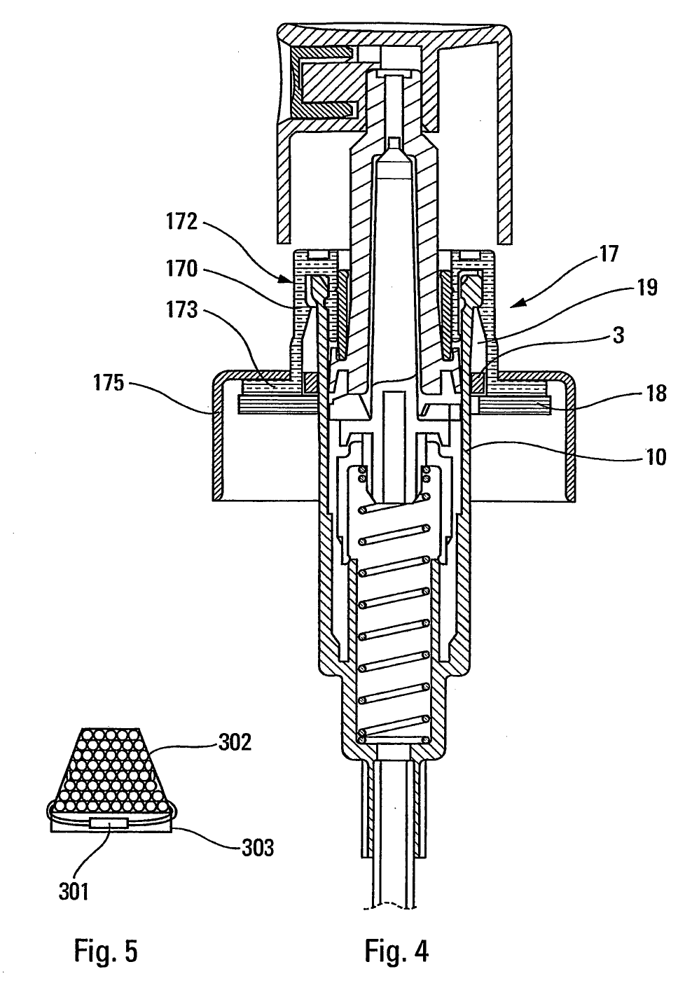

FIG. 4 is a section view through a fluid dispenser provided with a dispenser member constituting another embodiment of the invention; and

FIG. 5 is a section view of another embodiment of the radiofrequency ID unit.

The present invention applies to all dispenser members, such as pumps or valves. Consequently, the dispenser member 1 shown in the figures can be either a pump or a valve. The dispenser member 1 includes all of the components necessary for mounting it on a receptacle 2. To do this, the receptacle 2 has a neck 21 defining an opening 20 via which the inside of the receptacle 2 communicates with the outside.

The dispenser member 1 includes a body 10 defining an inlet sleeve 11 to which a dip tube 14 can be connected, and which extends inside the receptacle 2 down to its bottom wall. At its end remote from the inlet sleeve 11, the body 10 includes an outwardly-projecting rim 12. The dispenser member also includes an actuator rod 13 which is mounted to move in translation inside the body 10. The actuator rod 13 drives an element (not shown), which can be a piston in the case of a pump, or a valve member in the case of a valve. However, this is not critical in the present invention. An actuator member 15 in the form of a pusher is mounted on the top end of the actuator rod 13. In the example shown, the pusher 15 forms the dispenser orifice 16, e.g. in the form of a nozzle. The operation of such a dispenser member is very simple and well known: it suffices to press on the pusher 15 so as to displace the actuator rod 13 in the body 10, thereby dispensing an optionally-measured quantity of fluid through the actuator rod 13 to the dispenser orifice 16. This is entirely conventional for a pump or a valve in the fields of cosmetics, perfumery, or even pharmacy.

In order to fasten the body 10 in the opening 20 of the receptacle 2, fastener means 17 are provided, which, in this case, are in the form of a crimping collar. The crimping collar 17 forms a housing for receiving the rim 12 of the body 10, and also provides crimping around the neck 21. This is a non-limiting embodiment, since the fastener means can also be presented in the form of a ring or a turret, e.g. made of a plastics material which is engaged on the inside or on the outside of the neck, and which also forms a housing for receiving the rim 12 of the body 10. The particular form of the fastener means is not critical in the present invention. The fastener means can be presented in the form of a ring for screw-fastening, snap-fastening, or force-fitting. In the invention, it suffices that there is a gap between the fastener means and the body of the pump or of the valve.

To achieve a sealed fastening in the opening 20, the fastener means 17 advantageously include a neck gasket 18 designed to be compressed against the top end of the neck 21. So far the pump or valve as described above is entirely conventional.

In the invention, the dispenser member includes an ID unit 3 capable of supplying information relating to the dispenser member. The information supplied by the ID unit can be of any type: e.g. it can relate to information regarding the characteristics of the dispenser member: its date and place of manufacture, its destination, its shipping date, its date of reception, its place of reception, etc. By way of example, the information can be transmitted from the ID unit by radio. In this case, the ID unit can form a ring that can comprise an integrated circuit 301 associated with an antenna 302 forming a solenoid or silk-screen printing, for example, both embedded or encapsulated, by molding or some other means, in a substrate 303 made of resin or any other suitable material. This is shown in FIG. 3. FIG. 5 is a transverse view of a ring forming a radiofrequency unit representing, in another embodiment, the antenna 302 made up of a coil of precoated wires resting on the substrate 303 in which the integrated circuit 301 connected to said antenna 302 is embedded. This is conventional for an ID unit of the radiofrequency type. The integrated circuit stores information coming from an information transmission unit, which information is received by the antenna 302. To playback or deliver the information stored by the integrated circuit 301, a transmitter unit is also used which transmits an information-request signal that is received by the antenna 302, and in response to said information-request signal, the integrated circuit 301 plays back the stored information by means of the antenna 302.

Naturally, the use of such a radiofrequency ID unit is merely an example, and it should be understood that it is possible to use any type of ID unit which functions with some other technique for transmitting information.

With reference to FIGS. 1 and 2, it can be seen that the ID unit 3 is positioned in a gap 19. The gap forms an annular housing defined by the fastener means 17, the body 10, and the sealing gasket 18.

The ID unit 3 is held in the gap by any suitable means.

As can be seen, the ID unit 3 is associated with the body 10, said unit being housed in the gap 19, defined firstly by the neck gasket 18 disposed on the neck 21 of the receptacle 2, and secondly by the fastener means 17.

In the invention, the ID unit 3 is fastened, or formed, on the dispenser member, without having to modify the structure of the parts making up the dispenser, in particular the fastener means 17, the sealing gasket 18, and the body 10, and without having to add a special element to support the ID unit. Furthermore, the ID unit remains completely invisible from the outside, and cannot be removed from its location without damaging the dispenser significantly.

In an embodiment of the invention, a crimped portion 170 of the fastener means 17 that is housed below the rim 12 of the body defines the gap 19. The ID unit 3 can thus be configured so as to fit a flared shape 171 of said crimped portion 170. In this event, said ID unit includes a chamfered portion 30 facing said flared shape 171. Naturally, it is preferable to impart this shape to said ID unit 3, with a gap 19 being able to be formed to a greater or lesser extent by said unit 3 depending on the fastener means 17 used and their shape.

In the embodiment in FIG. 4, the fastener means 17 comprise a turret 172 and a crimping ring 175. The turret receives the body in a snap-fastener housing, and also forms a fastener flange 173. The flange is engaged with the crimping ring 175 in such a manner as to press the flange against the neck gasket so as to compress it against a receptacle neck.

The turret extends with a portion 170 coaxially around the body: an annular gap 19 is thus formed between them. At its bottom end, the gap 19 is also defined by the neck gasket.

An ID unit, which can be identical to the ID unit in FIGS. 1 to 3, is received or fastened in the gap.

In the present invention, the term “fastener means” should be understood as encompassing any single- or multiple-part device that serves to hold a fluid-dispenser member on or in an opening of a receptacle. The fastener means can even form a constituent element of the dispenser member, e.g. a blocking ferrule, as in FIG. 4.

In the invention, the ID unit 3 is a truly integral part of the dispenser member in the sense that it cannot be disassociated therefrom.

1. A fluid-dispenser member (1) comprising:
a body (10) defining an inlet duct (11);
an actuator rod (13) that is displaceable in the body;
an actuator member (15) coupled to the actuator rod;
fastener means (17) for fastening the body (10) in an opening (20) of a receptacle (2) containing a fluid; and
an ID unit (3) capable of supplying information relating to the dispenser member,
the dispenser member being characterized in that said ID unit (3) is housed in a gap defined between the body (10) and the fastener means (17).

2. A dispenser member according to claim 1, in which said gap (19) is defined by a neck gasket (18) disposed around the body, and designed to be compressed against the opening (20).

3. A fluid-dispenser member according to claim 1 or claim 2, in which said gap (19) forms an annular housing defined by the body (10), by a portion (170) of the fastener means (17), and by the neck gasket (18).

4. A fluid-dispenser member according to claim 3, in which said portion (170) is engaged below a rim (12) formed by the body.

5. A dispenser member according to claim 1, in which the ID unit (3) comprises an integrated circuit (301), and an antenna (302) capable of transmitting signals carrying information.

6. A dispenser member according to any preceding claim, in which the ID unit (3) is fastened to the body (10).

7. A dispenser member according to claim 5, in which the ID unit (3) includes a substrate (303) in or on which the integrated circuit (301) and the antenna (302) are disposed.

8. A dispenser member according to any preceding claim, in which the fastener means comprise a ring for crimping, screw-fastening, snap-fastening, or force-fitting.

9. A fluid dispenser comprising a receptacle (2) and a dispenser member (1) according to any preceding claim.
